(19) United States
(12) Patent Application Publication
(10) Pub. No.: US 2015/0193818 A1
(43) Pub. Date: Jul. 9, 2015

(54) Targeted Content Marketing Platform

(71) Applicant: DataOceans, LLC, Norcross, GA (US)

(72) Inventors: Mark Turner, Roswell, GA (US); Larry Buckley, Alpharetta, GA (US); Chien Hsiung, Suwanee, GA (US); Dave Hickson, Jupiter, FL (US); Thomas Buckley, Roswell, GA (US)

(21) Appl. No.: 14/590,500

(22) Filed: Jan. 6, 2015

Related U.S. Application Data
(60) Provisional application No. 61/925,475, filed on Jan. 9, 2014.

(51) Int. Cl. G06Q 30/02; G06F 17/24

(52) U.S. Cl. CPC G06Q 30/0251; G06F 17/243; G06F 17/248

(57) ABSTRACT

A Targeted Content Marketing (TCM) platform may be provided. Consistent with embodiments of the present disclosure, TCM platform may enable the dynamic placement of, for example, targeted messages, advertisements and/or onserts (hereinafter referred to as “content”) in various documents. The content may be placed within any portion of the document, including, but not limited to for example, the body, margins, various fields, and any white-space in the document. In addition to being effective with high-volume electronic document processing, TCM platform may be integrated with, but not limited to, for example, outbound printing and communication channels, interactive voice response (IVR) systems, and customer service (CSR) popup message prompts.

### RELATED APPLICATION

Under provisions of 35 U.S.C. §119(e), the Applicant claims the benefit of U.S. Provisional Application No. 61/925,475, filed Jan. 9, 2014, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to electronic document generation.

### BACKGROUND

Businesses often use templates for a variety of documents and customer communications. The various templates may include, for example, invoices, statements, estimates, letters, emails, etc. The use of templates makes it easy to mass-communicate documents to customers, and, when paired with a database, may allow for integration of individualized customer data into the documents.

However, conventional software may not have the capability of importing individualized customer data into, for example, PDF documents. This, in turn, significantly impedes the process of customization for high-volume documents. Therefore, there exists a need for a solution that may allow a user to easily customize documents of various file types while integrating, for example, a database comprising individual customer information.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a block diagram illustrating an operating environment for a Targeted Content Marketing (TCM) platform;

FIG. 2 illustrates a flow chart of a method for providing a TCM platform;

FIG. 3 illustrates a first user interface (UI) for an embodiment of a TCM platform;

FIG. 4 illustrates a second UI for an embodiment of a TCM platform;

FIG. 5 illustrates a third UI for an embodiment of a TCM platform;

FIG. 6 illustrates a fourth UI for an embodiment of a TCM platform;

FIG. 7 illustrates a fifth UI for an embodiment of a TCM platform; and

FIG. 8 is a block diagram of a computing device for providing the TCM platform.

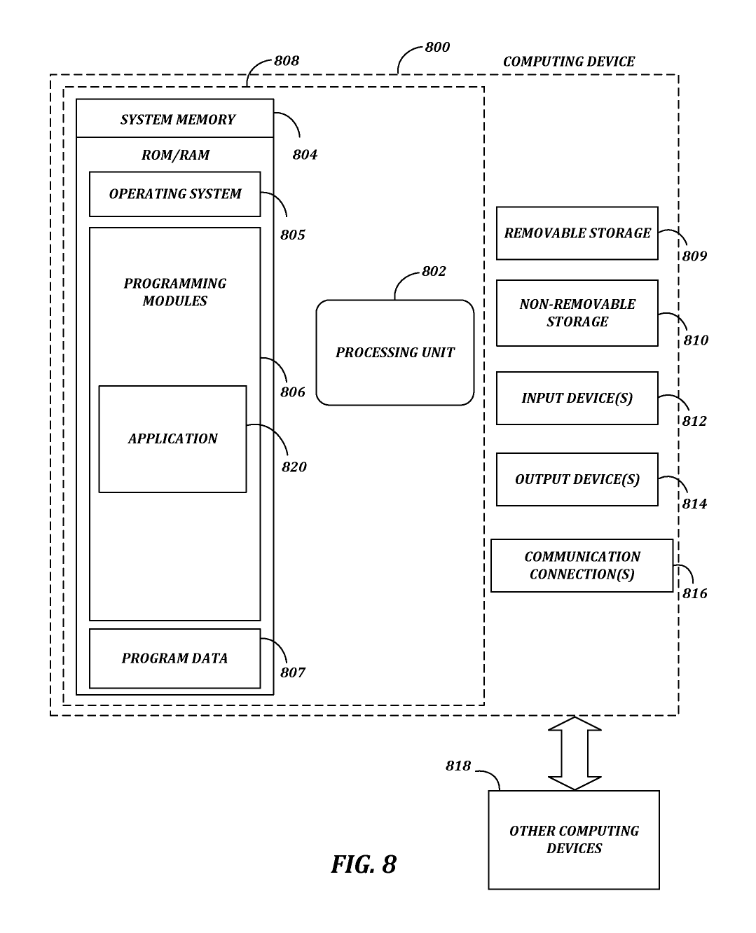

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

A Targeted Content Marketing (TCM) platform may be provided. Consistent with embodiments of the present disclosure, TCM platform may enable the dynamic placement of, for example, targeted messages, advertisements and/or onserts (hereinafter referred to as “content”) in various documents. The content may be placed within any portion of the document, including, but not limited to for example, the body, margins, various fields, and any white-space in the document. In addition to being effective with high-volume electronic document processing, TCM platform may be integrated with, but not limited to, for example, outbound printing and communication channels, interactive voice response (IVR) systems, and customer service (CSR) popup message prompts.

TCM platform consistent with embodiments of the present disclosure may comprise at least the following: a) a customer database providing information associated with a plurality of customers; b) at least one document to be customized and delivered to the customers (e.g., a template specification); c) content to be provided to the customers within the at least one document; and d) criteria for integrating the content into the at least one document.

TCM platform may be operative to integrate the content into a plurality of documents for each customer without being inhibited by factors such as, for example, the volume of designated customers associated with the documents (i.e., a size of the customer database comprising corresponding customer information). In various embodiments, the design, configuration and/or layout of TCM platform may provide a user interface such that it may not require computer programming knowledge to operate (i.e., it may be configured to receive, for example, content and criteria for integrating the content from a marketing professional without the assistance of a programmer or IT professional).

In this way, a TCM platform of the present disclosure may enable both mass customization of documents as well as individual personalization of documents. Such customizations may include, but be not limited to, for example, large easy-to-read fonts for seniors, sophisticated graphics and vibrant colors for GenX and GenY customers, luxuriant look and feel for platinum account customers, seasonal themes, and the like.

### II. PLATFORM CONFIGURATION

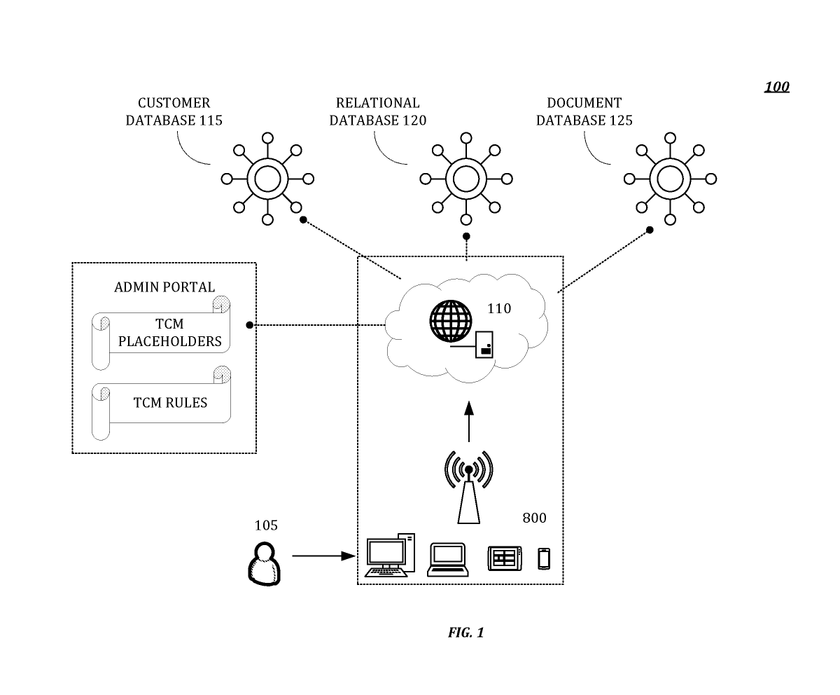

FIG. 1 illustrates one possible operating environment through which a platform consistent with embodiments of the present disclosure may be provided. By way of non-limiting example, a TCM platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device *00. One possible embodiment of the software application may be provided by the Targeted Content Manger suite of products and services provided by DataOceans LLC.

As will be detailed with reference to FIG. * below, the computing device through which the platform may be accessed may comprise, but not be limited to, for example, a desktop computer, laptop, a tablet, or mobile telecommunications device. As will be detailed with reference to FIG. * below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

a. Customer Database

As will be detailed below, TCM platform 100 may provide an admin User Interface (UI). The admin UI, among other functions, may enable user 105 to specify a customer database 115. TCM platform 100 may then be operative to parse customer database 115 with a data parsing component for subsequent mapping and integration with documents.

The parsed data derived from customer database 115 may then be mapped to a relational database 120. Relational database 120 may then be employed, as will be detailed below, by TCM platform 100 in the customization and personalization of documents. In some embodiments, TCM platform 100's architecture may be integrated with customer database 115 such that user 105 may not need to configure the platform's operation with customer database 115.

b. Template Specification

Consistent with embodiments of the present disclosure, the admin UI may further enable the user to specify a document database 125 comprising at least one document (e.g., a template) to be customized and delivered to a customer. TCM platform 100 may then retrieve the at least one document from, for example, document database 125 as specified by user 105. Document database 125 may comprise an electronic document file or a database of a plurality of files. The electronic files may comprise a plurality of templates, including, but not limited to, for example, invoices, statements, estimates, letters, and/or emails. Having established the document, TCM platform 100 may then prepare the document for customization and delivery. This may include, for example, identifying placeholder regions within the documents. As will be detailed below, the placeholder regions may serve as fields for receiving the content specified by user 105.

Still consistent with embodiments of the present disclosure, TCM platform 100 may be operative to establish and populate placeholder regions in content from a wide variety of sources, including, but not limited to, for example, data found in the print and communication streams of a computing system (including, networked computing systems).

c. Content Specification

User 105 of TCM platform 100 may be enabled to specify and edit the content to be integrated into a specified document (e.g., textual or graphical content to be placed into a document and delivered to a customer). As will be detailed below, the admin User Interface (UI) may enable user 105 to specify the content by directly inputting the customized information into input fields in the admin UI. The input fields may be configured to receive the content or a location (e.g., a uniform resource locator (URL)) associated with the content. In turn, the input fields may be mapped to the placeholder regions of a selected document. In this way, content entered into the input field of the admin UI may be integrated into the placeholder regions of the documents.

d. Content Integration

Having established the relational database, the document to be customized, and the content to be integrated into the document, TCM platform 100 may then receive a set of rules (hereinafter referred to as “TCM rules”) for integrating the content into the document. It should be noted that, although the present disclosure recites TCM platform 100's operation in a particular order, the disclosed order of operations is used for illustrative purposes and may be modified in various embodiments.

Consistent with embodiments of the present disclosure, the admin UI may be enabled to receive, from the user, content integration criteria. The integration criteria may be used by TCM platform 100 in establishing the set of TCM rules. The integration criteria may comprise, but not be limited to, for example, demographic information, geographic location, services received, services available, monthly revenue collected, credit worthiness, statements overdue, prior purchase history, etc. In addition, and as will be detailed below, the TCM rules may be based on the content or type of document provided for customization.

A TCM Rule may represent, for example, a set of logical statements and/or conditions, and it may be comprised of, but not limited to, for example, Boolean logic, complex optimization algorithms or other methods of creating logical statements and/or conditions. Accordingly, the TCM rules may then be used in comparing the integration criteria against the customer data in the relational database. In this way, TCM platform 100 may integrate the targeted content into documents intended for customers who meet the integration criteria.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### III. PLATFORM OPERATION

FIG. @ is a flow chart setting forth the general stages involved in a method @00 consistent with an embodiment of the disclosure for providing TCM platform 100. Method @00 may be implemented using a computing device *00 as described in more detail below with respect to FIG. *.

Although method @00 has been described to be performed by platform 100, it should be understood that computing device *00 may be used to perform the various stages of method @00. The computing device may comprise memory storage having a set of instructions for providing and operating TCM platform installed thereon. The computing device may reside in a conventional networking environment. In various embodiments, TCM platform may reside in a cloud computing environment. In this way, TCM platform may be provided in either a conventional stand-alone software program, a web-application, or a plug-in for various existing software and hardware.

Furthermore, in some embodiments, different operations may be performed by different networked elements in operative communication with computing device *00. For example, server 110 may be employed in the performance of some or all of the stages in method @00. Moreover, server 110 may be configured much like computing device *00.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method @00 will be described in greater detail below.

Method @00 may begin at stage @05, wherein TCM platform 100 may receive customer information. The customer information may be received from a variety of sources, including, for example, but not limited to, a database specified by an administrator of the platform, external demographic data, and/or customer profile data.

TCM platform 100 may use a data parser to parse the customer information. Having established a connection with a customer database 115 (e.g., a customer data source), the data parser may be operative to process to the data within the data source. In some embodiments, processing the data may comprise, but not be limited to, for example, mapping data file fields within the data source into relational database 120. Relational database 120, in turn, may be accessed by TCM platform in processing TCM rules for integrating content into documents.

From stage @05, method @00 may advance to stage @10 where TCM platform 100 may receive at least one document for integration and customization. The at least one document may be retrieved from, for example, a document database 125. Document database 125 may comprise an electronic document file or a database of a plurality of files. The electronic files may comprise a plurality of templates, including, but not limited to, for example, a Statement Template. Each template may comprise a plurality of data-fields.

TCM platform 100 may be operative to process the at least one document to determine at least one placeholder region. The placeholder region may comprise, for example, the body, margins, various fields, and any white-space in the document. In turn, TCM platform 100 may then update the at least one document to include the at least one placeholder region. As will be detailed below, the placeholder region may be designated to receive content (e.g., targeted and personalized messages and/or advertisements).

In various embodiments, TCM platform 100 may be integrated into, for example, data found in the print stream and other outbound communication streams of a computing system (including, networked computing systems). TCM platform 100 may detect that an outbound communication of a document has been initiated through, for example, a document print or transmission channel. In response, TCM platform 100 may intercept and process the document to establish and populate placeholder regions with the data.

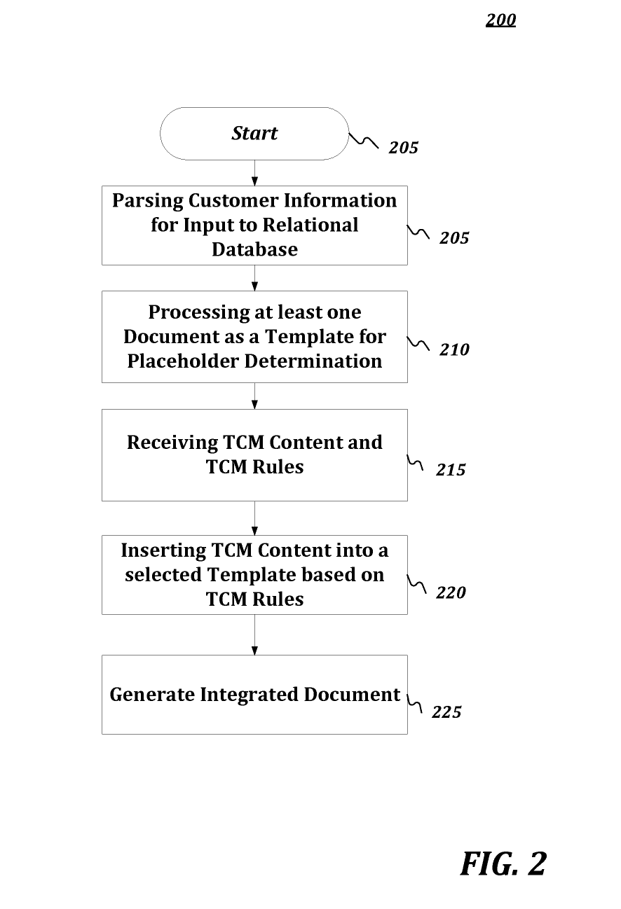

From stage @10, method @00 may proceed to stage @15 where TCM platform 100 may provide an admin user interface (UI). Various embodiments of the admin UI are detailed in FIGS. 2-6. The admin UI may be triggered in response to a user action. The user action may comprise, for example, a launching of a software, an access of a website associated with TCM platform 100, or an instantiation of a print command. In some embodiments, the triggering action may comprise a detection of printing or electronic communication of the document. Accordingly, the admin UI platform may be launched in response to, for example, a determination that the user has initiated a printing or other outbound communication stream associated with a document and or template. If the document in the print or communication stream has not been previously parsed by TCM platform 100, TCM platform may return to stage @15 to process the document.

The admin UI of TCM platform 100 may enable the user to specify at least the following: a) a document for customization; b) content to be integrated into the document; and c) criteria for integrating the content into the document.

Once the user has selected the document (if not previously detected by TCM platform 100), the admin UI may then enable the user to specify the content to be provided into the document. As mentioned above, the content may comprise, but not be limited to, for example, textual and/or graphical targeted messages advertisements and/or onserts (“content”) to be placed into the document.

The admin UI may provide the user with a plurality of input fields for specifying the content. In various embodiments, these input fields may be auto-populated by TCM platform 100 based, at least in part, on the parsed data in the relational database, the document, and/or the set of TCM rules as will be detailed below. The user may populate the input fields with a set of predetermined texts, graphics, and/or hyperlinks. These predetermined input elements may be set by an administrator of TCM platform 100. Yet in further embodiments, the user of the admin UI may directly input text, graphics, and/or hyperlinks into the input fields.

The input fields may further enable a user to specify a uniform resource locator (URL). The URL may be direct to, for example, a local or remote server comprising additional content. In turn, TCM platform 100 may be operative to embed the URL within the content and integrate the embedded content into the customized document. In this way, a viewer of the customized document may be provided with access to the additional content by, for example, clicking the targeted content within the document.

Still consistent with embodiments of the present disclosure, the admin UI may enable the user to input a plurality of criteria for integrating the content into the document. Said integration criteria may be specified by user 105 through input fields within the admin UI. The integration criteria may correspond to, for example, demographic information, geographic location, services received, services available, monthly revenue collected, credit worthiness, statements overdue, prior purchase history, etc. In turn, TCM platform 100 may be configured to determine the set of TCM Rules based on the received integration criteria from user 105.

In some embodiments, TCM platform 100 may determine the TCM rules based on data associated with the document such as, but not limited to, for example, meta-data associated with the certain templates, file types, or an external data source associated with the templates. For example, TCM platform 100 may be operative to establish rules that limit the dimensions of a particular text or image to be placed within a particular placeholder region of a document. These dimensions may be provided within, for example, the metadata associated with the document. Said metadata may be established during document processing in stage @10.

From stage @15, method @00 may enter stage @20 where the content (e.g., as received from the user in the placeholder input fields) may be placed within the document based on the TCM rules (e.g., as received from the user in the integration criteria input fields). In some embodiments, the user may first initiate a command to begin the mapping of the content to the placeholder regions of document.

In mapping the content to the placeholder regions of the document, TCM platform 100 may first determine which customer is associated with the document. Once it is determined which customer is associated with the document, TCM platform 100 may then access the relational database to retrieve customer information. Next, the customer information may be compared to the set of TCM rules established for the document.

By way of non-limiting example, a user may have specified an integration criteria for the content to be, for example, “home ownership.” In turn, TCM platform 100 may establish a TCM Rule that may cause the content to be placed in documents sent only to customers who are home owners, and not renters. Still consistent with embodiments of the present invention, TCM platform 100 may enable the user to specify a plurality of different placeholder content, each corresponding to a plurality of different TCM rules for a particular document. In turn, TCM platform 100 may analyze the relational database for customer data meeting the different TCM rules, and determine which placeholder content to place into the document. Moreover, in some embodiments, method @00 may perform a sub-stage wherein

TCM platform 100 may be operative to map the document data fields to the parsed data in relationship database 120. The mapping may also be based, at least in part, on the TCM rules. In this way, a document comprising data fields may be populated with the content as well as the information residing relational database 120 (e.g., customer information). From stage @25, method @00 may end at stage @25 where TCM platform 100 may generate PDFs from the integrated documents. Once the document has been integrated with the content, it may be placed back into the print or communication stream that is was received from. If the document was not received from a communication stream, then the integrated documents may be transmitted to a destination (e.g., a storage location or a delivery address) specified by the user. Furthermore, though the aforementioned operation was disclosed with reference to documents, a similar operation may be employed in integrating targeted content with IVR and CSR systems.

### IV. PLATFORM INTERFACE

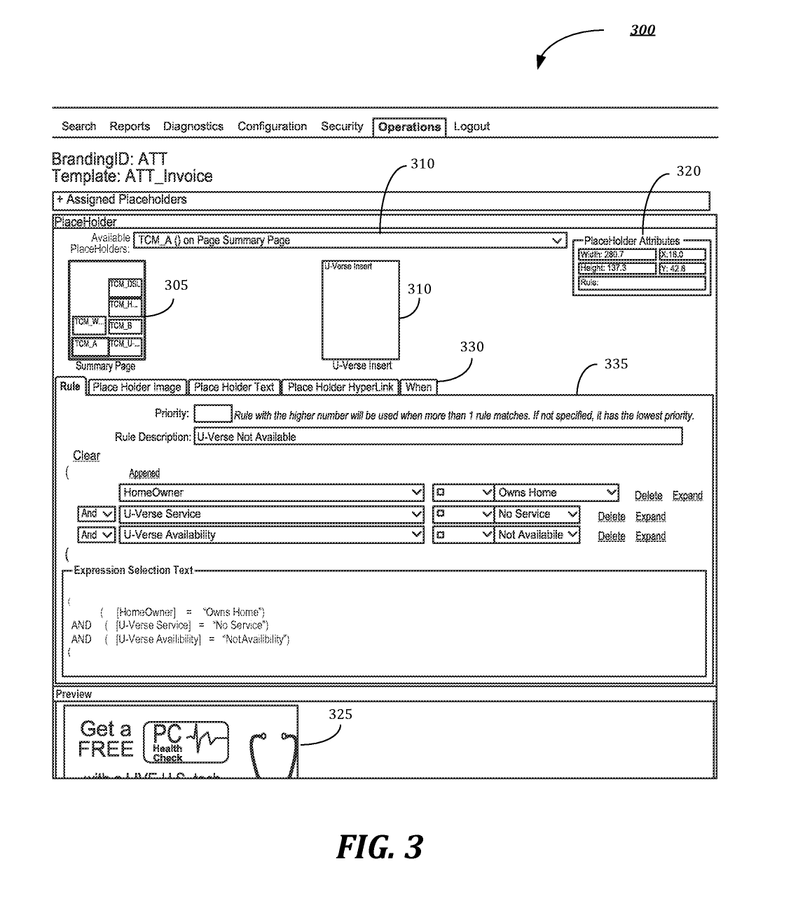

As disclosed above, the TCM Platform may provide an admin user interface (UI). The admin UI, among a plurality of other functions, may enable a user to select a document (e.g., a Statement Template) and specify integration criteria to create TCM rules to apply to it. One embodiment of an admin UI 300 is illustrated in FIG. 3. Admin UI 300 may comprise various elements, such as, but not limited to: a display of available placeholders 305 (e.g., content to be placed into the document), a means for selecting a particular placeholder 310, such as, but not limited, a dropdown menu or a selectable graphical user interface (GUI), a display of a selected placeholder 315, a display of placeholder attributes 320, a preview 325 of the message or advertisement to be inserted into the document, and a series of tabs 330 labeled, for example, “Rules,” “Place Holder Image,” “Place Holder Text,” “Place Holder Hyperlink” and “When.” The display of placeholder attributes 320 may contain information about the width and height of the placeholder, the X and Y coordinates of the placeholder on the template, and the rule(s) relating to the placeholder.

FIG. 3 illustrates an embodiment of an admin UI 300, wherein a “Rule” tab has been selected. A Rule tab may enable a user to input desired integration criteria 335, in order to create TCM Rules, which may, in turn, represent the desired conditions under which the designated content placeholder should be applied to the template. A Rule tab may comprise various elements, such as, but not limited to, a text box for providing a description of a TCM Rule, a text box for specifying the priority of a TCM Rule, a text box displaying or allowing the input of the logical expression of the integration criteria, and a means for inputting integration criteria (i.e., a means for creating a TCM Rule), such as, for example, but not limited to, a series of drop down menus containing data fields, Boolean logic symbols and/or mathematical symbols arranged such that they may be used to create TCM Rules comprising specified logical conditions.

In some embodiments of the present disclosure, TCM Rules may be created through the use of complex algorithms based on integration criteria input by a user. In the event that there may be a conflict between one or more TCM Rules, a Rule tab may enable a user may specify the priority of each TCM Rule. Various Rule tab elements may be automatically populated by data fields which may correspond to data found in, for example, the relational database and/or preset by an administrator of the platform. As illustrated in FIG. 3, a user has inputted integration criteria to create a TCM Rule designed to identify customers who own their home, do not have U-Verse service and do not have U-Verse service available to them.

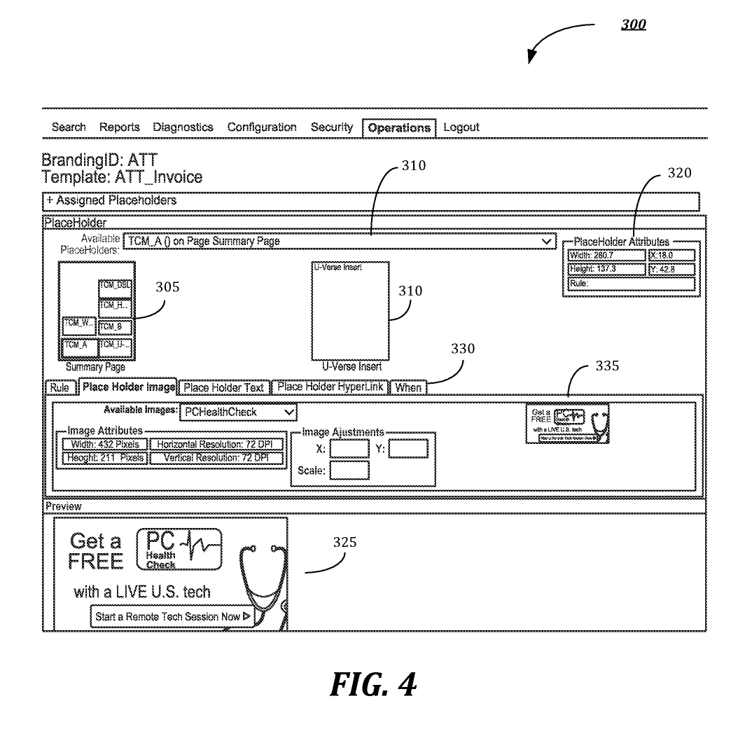

FIG. 4 illustrates an embodiment of an admin UI, wherein the “Place Holder Image” tab has been selected. A Place Holder Image tab may enable a user to select a desired place holder image to associate with the selected place holder. A place holder image may comprise, for example, a message to a customer or an advertisement. A Place Holder Image tab may comprise various elements, for example, but not limited to, a means for selecting a place holder image, a display of place holder image attributes, a display of the selected place holder image, and a means for making adjustments to the place holder image. A means for selecting a place holder image may comprise, for example, a drop down menu listing the available place holder images predetermined by, for example, an administrator of the platform.

A display of place holder image attributes may comprise image attributes such as width, height, horizontal resolution and vertical resolution. A means for making adjustments to the place holder image may comprise, for example, text boxes enabling a user to input adjustments based on the X-axis of the image, the Y-axis of the image or the scale of the image.

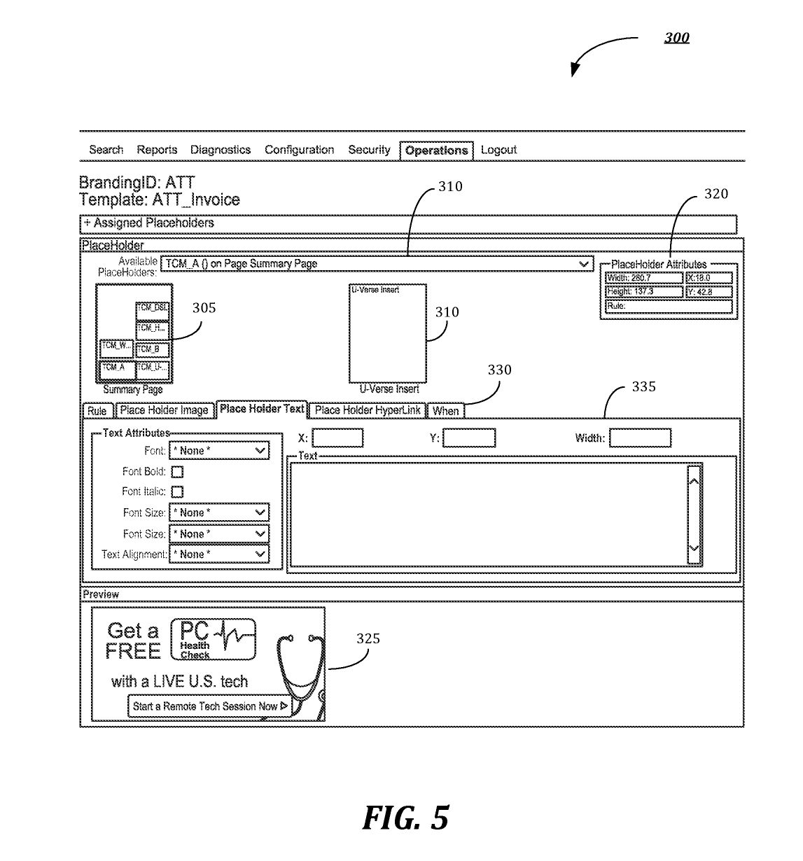

FIG. 5 illustrates an embodiment of admin UI 300, wherein the “Place Holder Text” tab has been selected. A Place Holder Text tab may enable a user to input text information associated with the selected place holder. A Place Holder Text tab may comprise various elements, for example, but not limited to, a means for inputting place holder text, a means for inputting text attributes, and a means for inputting text location data. A means for inputting place holder text may comprise, for example, a text box. Text attributes may include, but be not limited to, font type, bold font, italics font, font size, text color and text alignment. A means for inputting text attributes may comprise, for example, some combination of check boxes, radio buttons, drop down menus and the like. A means for inputting text location data may comprise, for example a series of text boxes wherein a user may specify the location of placeholder text on the X-axis or Y-axis or may specify the width of the text.

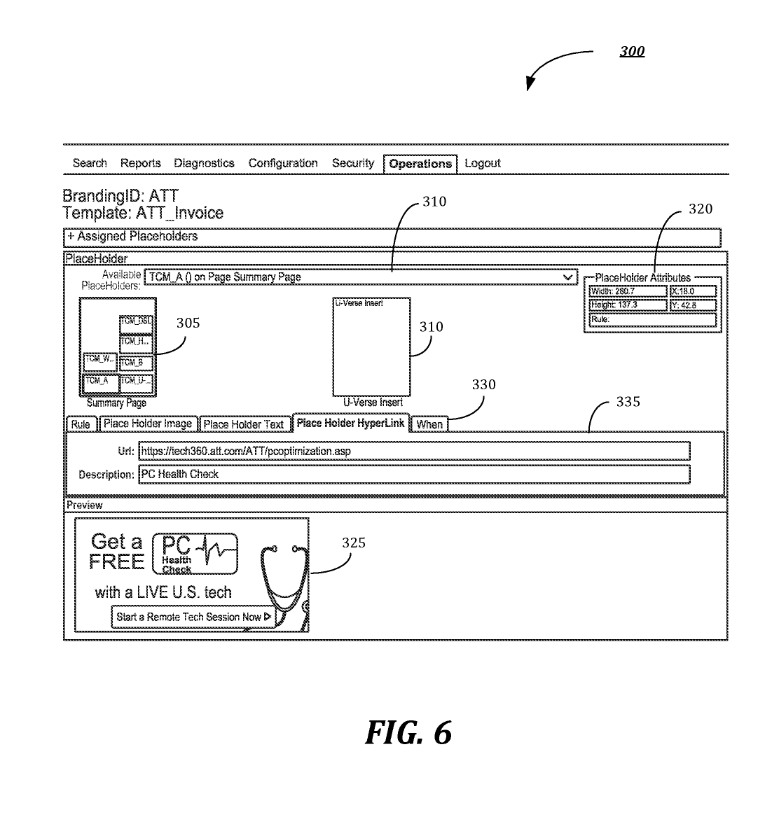

FIG. 6 illustrates an embodiment of admin UI 300, wherein the “Place Holder HyperLink” tab has been selected. A Place Holder HyperLink tab may enable a user to associate a uniform resource locater (URL) with a placeholder. In some embodiments of the present disclosure, a Place Holder HyperLink tab may comprise a text box for specifying a URL and a text box for providing a description of the URL. In electronic documents, the placeholder may provide a hyperlink to a URL specified by a user.

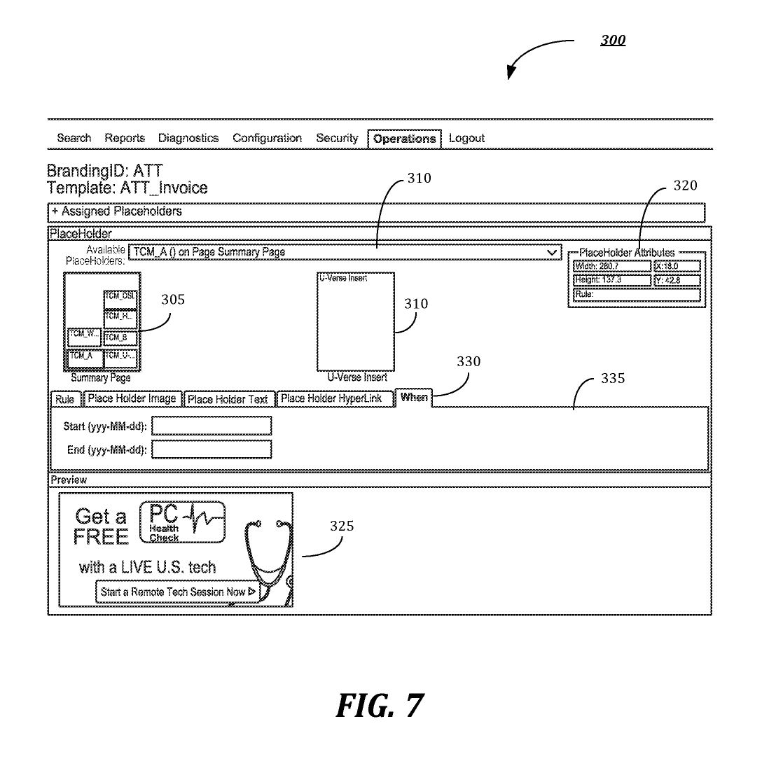

FIG. 7 illustrates an embodiment of an admin UI, wherein the “When” tab has been selected. A When tab may enable a user to specify a range of dates wherein the specified place holder image shall be applied to the template in accordance with the specified TCM Rule. In some embodiments of the present disclosure, a When tab may comprise a first text box enabling a user to enter a start date, and a second text box enabling a user to enter an end date. In other embodiments, a When tab may comprise a calendar enabling a user to select start and end dates.

### V. PLATFORM ARCHITECTURE

The TCM platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the TCM platform 100 may be hosted on a centralized server, such as, for example, a cloud computing service. Although method @00 has been described to be performed by a computing device *00, it should be understood that, in some embodiments, different operations may be performed by different networked elements in operative communication with computing device *00.

Embodiments of the present disclosure may comprise a system having a memory storage and a processing unit. The processing unit coupled to the memory storage, wherein the processing unit is configured to perform the stages of method @00.

FIG. * is a block diagram of a system including computing device *00. Consistent with an embodiment of the disclosure, the aforementioned memory storage and processing unit may be implemented in a computing device, such as computing device *00 of FIG. *. Any suitable combination of hardware, software, or firmware may be used to implement the memory storage and processing unit. For example, the memory storage and processing unit may be implemented with computing device *00 or any of other computing devices *18, in combination with computing device *00. The aforementioned system, device, and processors are examples and other systems, devices, and processors may comprise the aforementioned memory storage and processing unit, consistent with embodiments of the disclosure.

With reference to FIG. *, a system consistent with an embodiment of the disclosure may include a computing device, such as computing device *00. In a basic configuration, computing device *00 may include at least one processing unit *02 and a system memory *04. Depending on the configuration and type of computing device, system memory *04 may comprise, but is not limited to, volatile (e.g. random access memory (RAM)), non-volatile (e.g. read-only memory (ROM)), flash memory, or any combination. System memory *04 may include operating system *05, one or more programming modules *06, and may include a program data *07. Operating system *05, for example, may be suitable for controlling computing device *00's operation. In one embodiment, programming modules *06 may include TCM application *20. Furthermore, embodiments of the disclosure may be practiced in conjunction with a graphics library, other operating systems, or any other application program and is not limited to any particular application or system. This basic configuration is illustrated in FIG. * by those components within a dashed line *08.

Computing device *00 may have additional features or functionality. For example, computing device *00 may also include additional data storage devices (removable and/or non-removable) such as, for example, magnetic disks, optical disks, or tape. Such additional storage is illustrated in FIG. * by a removable storage *09 and a non-removable storage *10. Computer storage media may include volatile and nonvolatile, removable and non-removable media implemented in any method or technology for storage of information, such as computer readable instructions, data structures, program modules, or other data. System memory *04, removable storage *09, and non-removable storage *10 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device *00. Any such computer storage media may be part of device *00. Computing device *00 may also have input device(s) *12 such as a keyboard, a mouse, a pen, a sound input device, a touch input device, etc. Output device(s) *14 such as a display, speakers, a printer, etc. may also be included. The aforementioned devices are examples and others may be used. Computing device *00 may also contain a communication connection *16 that may allow device *00 to communicate with other computing devices *18, such as over a network in a distributed computing environment, for example, an intranet or the Internet. Communication connection *16 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory *04, including operating system *05. While executing on processing unit *02, programming modules *06 (e.g., TCM application *20) may perform processes including, for example, one or more of method @00's stages as described above. The aforementioned process is an example, and processing unit *02 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### VI. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising;
processing a document to determine at least one placeholder region within the document;
receiving content to be inserted into the at least one placeholder region;
receiving rules for inserting the content into the at least one placeholder region; and
inserting the content into the at least one placeholder region based on the rules.

2. The method of claim 1, wherein processing the document to determine the at least one placeholder region comprises:
accessing a data source comprising a plurality of documents to be used as templates, and
processing each of the plurality of documents to determine the at least one placeholder regions for each document.

3. The method of claim 1, wherein processing the document to determine the at least one placeholder region comprises mapping at least one portion the document, the at least one portion of the comprising at least one of the following: whitespace within the document and a data field input region within the document.

4. The method of claim 1, further comprising receiving a selection of the processed document for use a template.

5. The method of claim 1, further comprising displaying a plurality of placeholder regions available within the processed document.

6. The method of claim 1, further comprising receiving selection of the at least one placeholder region within the document to receive the content.

7. The method of claim 1, wherein receiving the content to be inserted into the at least one placeholder region comprises receiving at least one of the following: textual content, graphical content, and a uniform resource locator (URL).

8. The method of claim 1, further comprising, prior to inserting the content:
parsing customer information within a customer database; and
storing the parsed customer information within a relational database.

9. The method of claim 8, wherein inserting the content into the at least one placeholder region based on the rules comprises accessing the relational database to assess the rule for content insertion.

10. The method of claim 8, wherein receiving rules for inserting the content into the at least one placeholder region comprises receiving criteria for the customer information.

11. The method of claim 10, wherein inserting the content into the at least one placeholder region based on the rules comprises accessing the relational database to determine whether the criteria for the customer information is met.

12. The method of claim 1, further comprising generating an electronic document based on the processed document with the inserted content.

13. The method of claim 12, further comprising communicating the generated electronic document.

14. The method of claim 13, wherein communicating the generated electronic document comprises at least one of the following:
transmitting the electronic document via an output print stream, and emailing the electronic document.

15. A computer-readable medium having a set of instructions which when executed are configured to perform a method comprising;
accessing a data source comprising a plurality of documents to be used as templates;
processing each of the plurality of documents to determine at least one placeholder regions for each document;
receiving a selection of a processed document to be used as a template;
receiving content to be inserted into the at least one placeholder region of the processed document;
receiving rules for inserting the content into the at least one placeholder region of the processed document; and
inserting the content into the at least one placeholder region based on the rules.

16. The computer-readable medium of claim 15, wherein processing each of the plurality of documents to determine the at least one placeholder region comprises mapping at least one portion each document, the at least one portion of the comprising at least one of the following: whitespace within the document and a data field input region within the document.

17. The computer-readable medium of claim 15, further comprising displaying a plurality of placeholder regions available within the selected processed document.

18. The computer-readable medium of claim 15, further comprising, prior to inserting the content:
parsing customer information within a customer database; and
storing the parsed customer information within a relational database.

19. The computer-readable medium of claim 18, wherein inserting the content into the at least one placeholder region based on the rules comprises accessing the relational database to assess the rule for content insertion.

20. A system comprising;
a memory storage; and
a processing unit coupled to the memory storage, wherein the processing unit is operative to:
access a first data source comprising a plurality of documents to be used as templates,
process each of the plurality of documents to determine at least one placeholder regions for each document,
access a second data source comprising a plurality of customer information;
parse the customer information within the second data source,
storing the parsed customer information within a relational database,
receive a selection of a processed document to be used as a template,
receive content to be inserted into the at least one placeholder region of the processed document,
receive rules for inserting the content into the at least one placeholder region of the processed document, the rules comprising relational database criteria, and
insert the content into the at least one placeholder region based on the rules.
